(19) United States
(12) Patent Application Publication
(10) Pub. No.: US 2011/0088559 A1
(43) Pub. Date: Apr. 21, 2011

(54) COFFEE BREWING SYSTEM

(75) Inventors: William Alexis Dahmen, Goshen, KY (US); Thomas J. Pfeifer, Louisville, KY (US); Timothy D. Gantt, Goshen, KY (US)

(73) Assignee: GRINDMASTER CORPORATION, Louisville, KY (US)

(21) Appl. No.: 12/759,442

(22) Filed: Apr. 13, 2010

Related U.S. Application Data
(60) Provisional application No. 61/168,788, filed on Apr. 13, 2009.

(51) Int. Cl. A47J 31/44; A47J 31/46; A47J 31/56; A47J 31/50

(52) U.S. Cl. 99/281; 99/283; 99/285; 99/291; 99/300

(57) ABSTRACT

A coffee brewing system comprises: a housing defining an interior cavity for storing a volume of water; a fill valve for controlling flow of water into the interior cavity through an inlet pipe; a plurality of liners housed within the interior cavity and surrounded by the water in the interior cavity; one or more heating elements positioned within the interior cavity to heat and maintain the temperature of the water; a plurality of brew baskets, each of which is received in one of the plurality of liners and configured for holding a quantity of coffee grounds; a plurality of pivoting spray arm assemblies, each said pivoting spray arm assembly configured for pivotal movement relative to the housing; one or more pumps, each said pump for conveying water from the interior cavity of the housing to a respective pivoting spray arm assembly, which then delivers the water to a selected brew basket for making brewed coffee; and a control system for controlling operation of each said pump, each said heating element, and said fill valve.

### CROSS-REFERENCE TO RELATED APPLICATIONS

The present application claims priority to U.S. Provisional Patent Application Ser. No. 61/168,788 filed on Apr. 13, 2009, the entire disclosure of which is incorporated herein by reference.

### TECHNICAL FIELD

The present invention is a coffee brewing system that allows greater control over the quality of the coffee, makes it easier to brew coffee in a consistent manner, while also addressing other problems of prior urn constructions.

### BACKGROUND OF THE INVENTION

Various coffee brewing systems exist in the prior art in which brewed coffee is held in and dispensed from one or more liners. The exterior housing in such an “urn” construction defines an interior cavity for storing a volume of water, and there are heating elements in the interior cavity for heating the water. Each of the liners is then seated in a respective opening defined through the top surface of the housing, so that the liner is surrounded by the heated water. In making the brewed coffee, a brew basket is received in each of the liners for holding a quantity of coffee grounds in a filter. Hot water is directed over the coffee grounds by a spray arm, and the brewed coffee passes through the filter and the openings of the brew basket into the liner. However, there are various problems with prior urn constructions.

For example, prior urn constructions often do not allow for much control over the water delivery, which can lead to an imprecise volume of water being delivered from the spray arm over the coffee grounds. Alternatively, to the extent that the spray arm can be pivoted into and out of position over the coffee grounds, there is the possibility of water spillage when the spray arm is not properly positioned over the brew basket.

For another example, in prior urn constructions, the heating elements are commonly positioned in the center of the interior cavity (or tank), and as such, the temperature of the water near one liner might be greater than that of another liner. Such differences in temperature can lead to quality differences with respect to the brewed coffee.

For yet another example, if it is desirable to brew a smaller batch of coffee, a smaller amount of coffee grounds must be used. However, placing a smaller amount of coffee grounds in a brew basket designed for larger quantities will cause the layer of coffee grounds in the brew basket to be too thin and will cause the coffee grounds to be over-extracted. Furthermore, prior urn constructions do not compensate for the shorter brew time required in brewing a smaller batch of coffee, such as a half batch. Rather, in prior art constructions, brewing a half batch of coffee violated industry coffee brewing standards with respect to the required contact time between the coffee grounds and the hot water. The shorter contact time in a half batches of coffee again produces a coffee that is not properly extracted and will often be of poor quality.

For yet another example, the sight glasses used in prior urn constructions are often fragile and also difficult to read when residue accumulates on the sight glass. Residue from the sight glass can also contaminate future batches of coffee, and when using a sight glass, the temperature of the coffee is lowered because a portion of the coffee that is poured out into each cup comes from the portion of coffee in the sight glass.

### SUMMARY OF THE INVENTION

The present invention is a coffee brewing system that allows greater control over the quality of the coffee, makes it easier to brew coffee in a consistent manner, while also addressing other problems of prior urn constructions.

An exemplary coffee brewing system made in accordance with the present invention includes: a housing that defines an interior cavity for storing a volume of water; a fill valve for controlling flow of water into the interior cavity through an inlet pipe; one or more heating elements in the interior cavity for heating the water; a plurality of liners, each of which are housed within the interior cavity and surrounded by the water; a plurality of pivoting spray arm assemblies for delivering water to the liners; a plurality of brew baskets, each received in a respective liner and configured for holding a quantity of coffee grounds; one or more pumps for conveying water from the interior cavity of the housing to a respective pivoting spray arm assembly; and a control system for controlling operation of the fill valve, the heating elements, and the pumps. There are also various controls, sensors, and displays in communication with the control system for monitoring and reporting on the operation of the exemplary coffee brewing system.

The heating elements in the interior cavity of the housing are “staggered,” with a respective heating element positioned near each liner, in an effort to maintain a consistent water temperature. By staggering the heating elements and positioning each heating element near a respective liner, consistent and optimal brewed coffee temperatures can be maintained at each liner.

Hot water from the interior cavity is delivered to the liners and through respective brew baskets received in the liners by the spray arm assemblies. Specifically, water is drawn through a pump inlet by a respective pump, and then delivered through a respective outlet pipe to one of the two spray arm assemblies. Each spray arm assembly is configured for pivotal movement relative to the housing and between two of the liners.

Brewed coffee is then dispensed from each liner via a dispensing nozzle on the external surface of the housing that is in fluid communication with a respective liner via a delivery tube. In one exemplary embodiment, each liner is connected to a coupling, which places each liner in fluid communication with a respective delivery tube.

With respect to each spray arm assembly, a downwardly extending bracket is also secured to each spray arm assembly. This bracket pivots with the pivoting of the spray arm assembly, and will engage left and right stops at the base of the spray arm assembly to prevent over-rotation of the spray arm assembly. Furthermore, a magnet is preferably secured near the distal end of this bracket. A magnetic proximity sensor assembly is located near each spray arm assembly. This magnetic proximity sensor assembly can provide information as to the position of the spray arm assembly by sensing the relative position of the magnet.

An exemplary coffee brewing system made in accordance with the present invention also includes a control system comprised of a control logic on an electronic control board. The control logic receives signals from the magnetic proximity sensor assemblies, signals that are representative of the relative position of each spray arm assembly. Thus, the control logic can verify the position of the spray arm assemblies before starting a brew cycle. The control logic also controls the pumps, the heating elements, and the fill valve. In determining how to control these various components, the control logic relies on inputs from various sensors and from the user via a main display user interface.

With respect to the control logic, an exemplary coffee brewing system made in accordance with the present invention may also include lengths of tubing that are in fluid communication with the internal volume defined by each of the liners and operably connected to a pressure sensor. The pressure sensor communicates a signal to the control logic representative of the measured head pressure in each length of tubing. Since the pressure in each length of tubing is dependent on the volume of brewed beverage in a respective liner, by measuring the pressure, the liquid level in each liner can be determined by the control logic. The control logic then communicates with level displays, each of which provides a visual indication of the liquid level in a particular liner.

As a further refinement, an exemplary coffee brewing system made in accordance with the present invention may also include air agitation pumps to deliver air to the liners in order to agitate the brewed coffee at the end of the brewing cycle or at other selected intervals. These air agitation pumps can be programmed by the user to automatically agitate the brewed coffee at designated times and/or at predetermined intervals.

As a further refinement, an exemplary coffee brewing system made in accordance with the present invention may also include brew baskets that can accommodate different amounts of coffee grounds, depending on the amount of brewed coffee to be made. For example, if it is desirable to brew a smaller batch of coffee, an insert may be received in the brew basket. The filter and coffee grounds are placed in this insert, and so the same coffee brewing system can be used to brew the smaller batch of coffee without any degradation in quality.

### DESCRIPTION OF THE DRAWINGS

FIG. 1 is a perspective view of an exemplary coffee brewing system made in accordance with the present invention;

FIG. 1A is an alternate perspective view of the exemplary coffee brewing system of FIG. 1, with one of the liners, its associated brew basket, and its cover removed from the remainder of the exemplary coffee brewing system to illustrate the relative position of these components;

FIG. 2 is a front view of the exemplary coffee brewing system of FIG. 1;

FIG. 3 is a top view of the exemplary coffee brewing system of FIG. 1;

FIG. 4 is a rear view of the exemplary coffee brewing system of FIG. 1;

FIG. 5 is a partial view of the exemplary coffee brewing system of FIG. 1, with various external housing components and the liners removed to illustrate various internal components, including the heating elements and pumping components;

FIG. 6 is a perspective view of a liner from the exemplary coffee brewing system of FIG. 1;

FIG. 6A is a sectional view of the liner of FIG. 6;

FIG. 7 is a perspective view of a spray arm assembly from the exemplary coffee brewing system of FIG. 1;

FIG. 7A is an exploded perspective view of the spray arm assembly of FIG. 7;

FIG. 8 is a perspective view of an alternate spray arm assembly for use with an exemplary coffee brewing system made in accordance with the present invention;

FIG. 8A is an exploded perspective view of the spray arm assembly of FIG. 8;

FIG. 9 is a perspective view of the post assembly of the spray arm assembly of FIG. 7;

FIG. 9A is an exploded perspective view of the post assembly of FIG. 9;

FIG. 10 is a perspective view of the brew basket of the exemplary coffee brewing system of FIG. 1;

FIG. 11 is an exploded perspective view of the brew basket of FIG. 10 and further illustrates an insert that is received in the brew basket;

FIG. 12 is a schematic diagram of the control system for the exemplary coffee brewing system of FIG. 1; and

FIGS. 13A AND 13B are logic diagrams that illustrate exemplary subroutines carried out by the control logic in the exemplary coffee brewing system of FIG. 1.

### DETAILED DESCRIPTION OF THE INVENTION

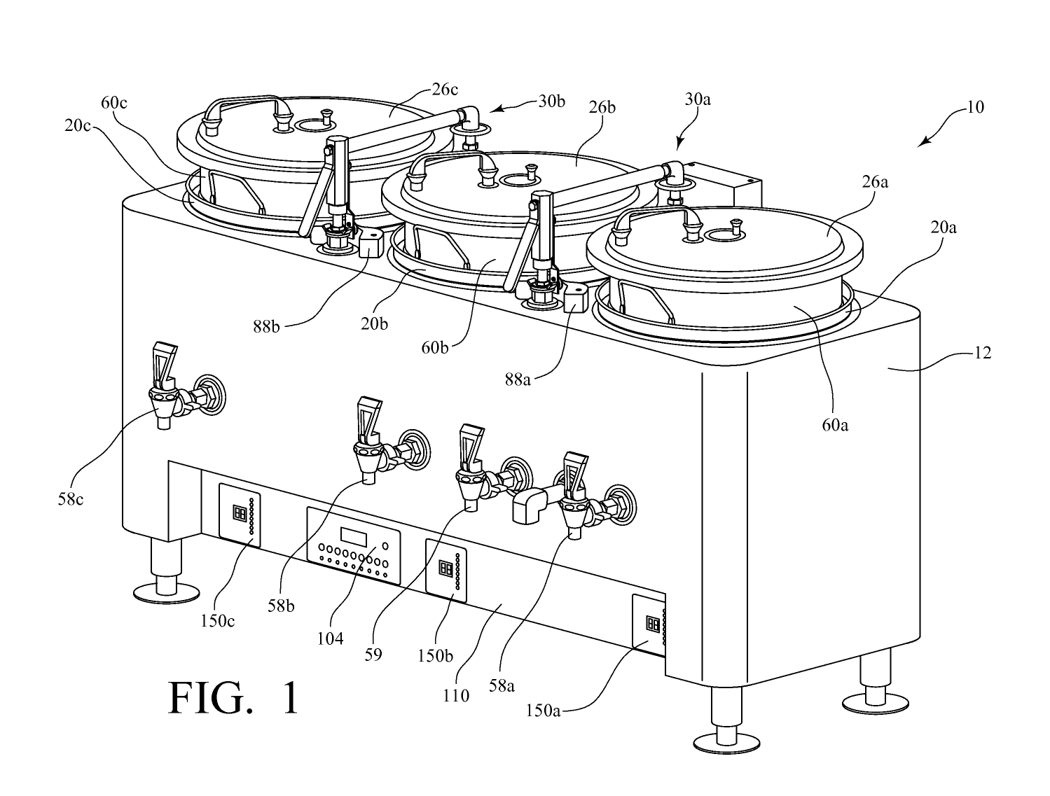

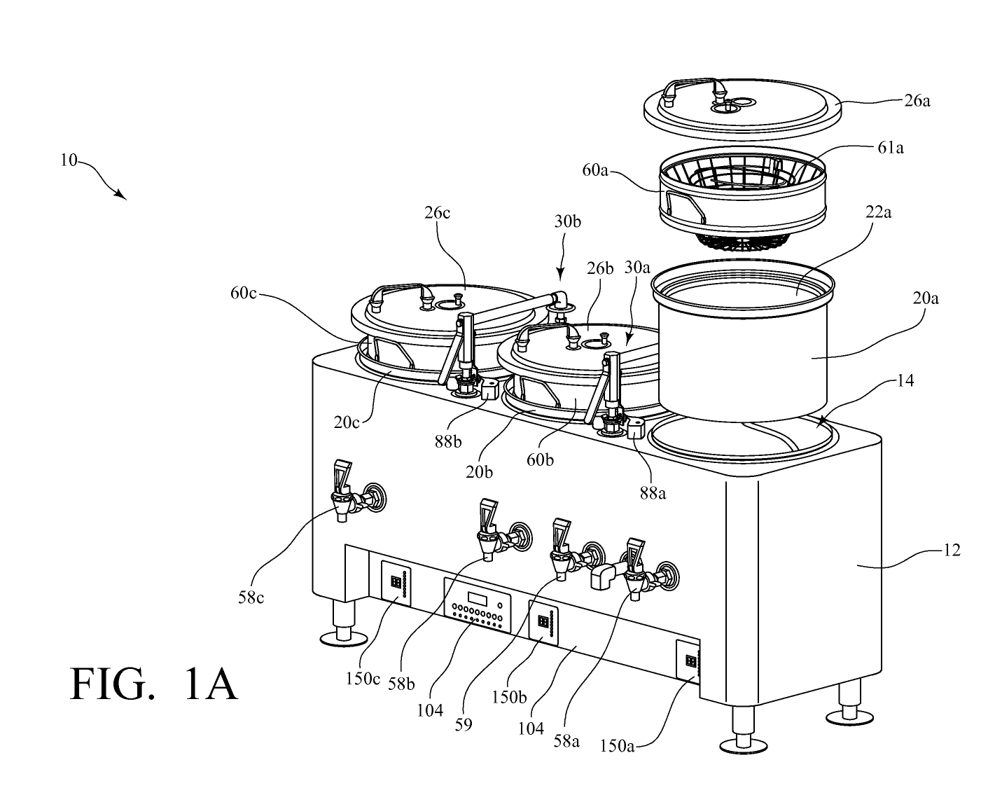

FIGS. 1-5 are various views of an exemplary coffee brewing system 10 made in accordance with the present invention. The coffee brewing system 10 of the present invention may also be referred to as an “urn.” In the exemplary embodiment shown in FIGS. 1-5, the urn 10 includes: a housing 12 that defines an interior cavity 14 for storing a volume of water; a fill valve 116 for controlling flow of water into the interior cavity through an inlet pipe 16; heating elements 70a, 70b, 70c in the interior cavity 14 for heating the water; three liners 20a, 20b, 20c, each of which are housed within the interior cavity 14 and surrounded by the water, and each liner 20a, 20b, 20c having a generally cylindrical shape defining an internal volume 22a, 22b, 22c and an open end 24a, 24b, 24c; covers 26a, 26b, 26c for the respective liners 20a, 20b, 20c; two pivoting spray arm assemblies 30a, 30b for delivering water to the three liners 20a, 20b, 20c; three brew baskets 60a, 60b, 60c, each received in a respective liner 20a, 20b, 20c and configured for holding a quantity of coffee grounds; two pumps 82a, 82b for conveying water from the interior cavity 14 of the housing to a respective pivoting spray arm assembly 30a, 30b; and a control system for controlling operation of the fill valve 116, the heating elements 70a, 70b, 70c, and the pumps 82a, 82b. There are also various controls, sensors, and displays in communication with the control system for monitoring and reporting on the operation of the exemplary coffee brewing system 10, as described in detail below.

The housing 12 is generally rectangular in shape, and the interior cavity 14 has a sufficient volume to accommodate and house the three liners 20a, 20b, 20c. Three openings are defined through the top surface of the housing 12, and each of the three liners 20a, 20b, 20c is seated in a respective opening, as perhaps best shown in FIG. 1A. Furthermore, a volume of water is stored in the interior cavity 14, such that the housing 12 also acts as a hot water tank, with water held in the tank and surrounding each of the three liners 20a, 20b, 20c. Therefore, the brewed coffee within each liner 20a, 20b, 20c can be maintained in an optimal temperature range of approximately 180° F. to 185° F. The housing is preferably made of stainless steel, but other suitable materials can also be used without departing from the spirit or scope of the present invention.

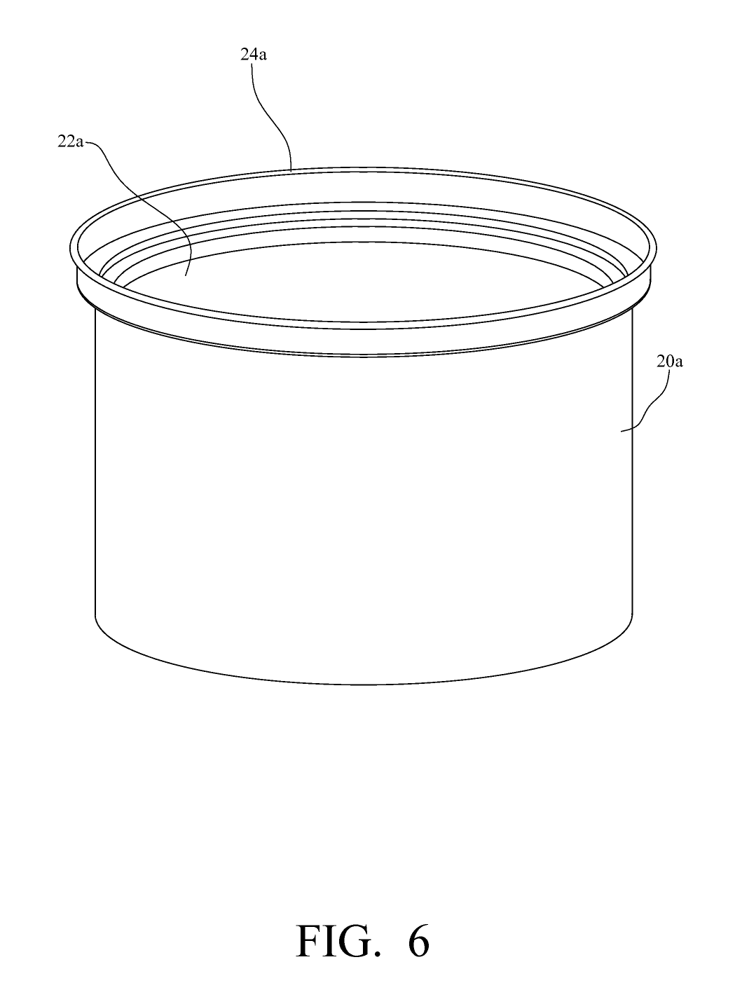

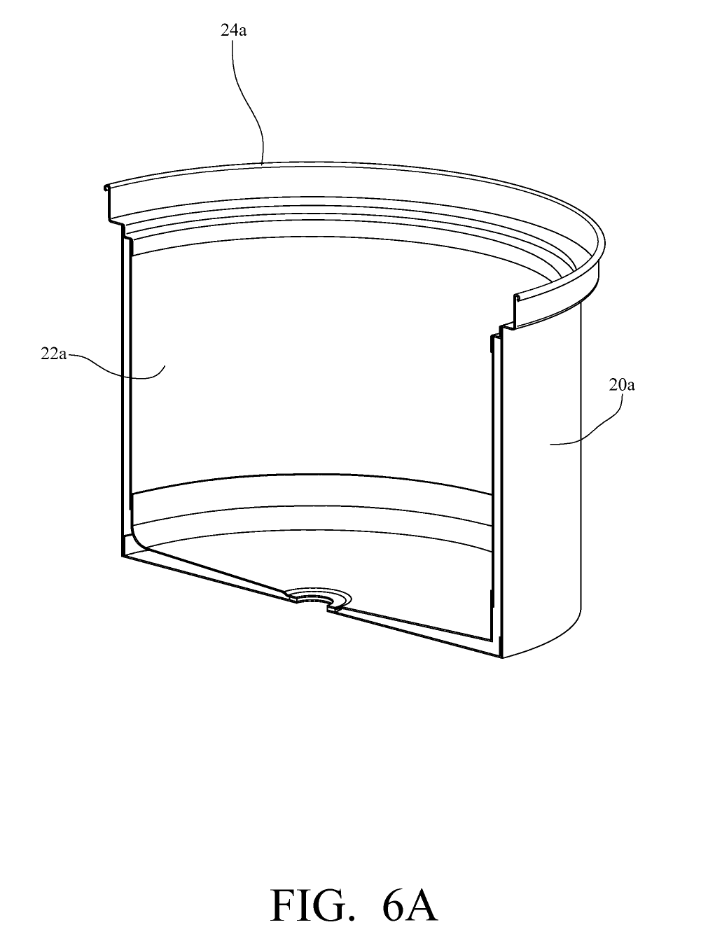

As mentioned above, each of the three liners 20a, 20b, 20c is received in the interior cavity 14 of the housing 12. In this regard, three openings are defined through the upper surface of the housing 12, and each of the three liners 20a, 20b, 20c is seated in a respective opening, with a circumferential flange around the upper lip of each liner 20a, 20b, 20c engaging the upper surface of the housing 12. Each liner 20a, 20b, 20c is also preferably made of stainless steel. Furthermore, in this exemplary embodiment and as shown in FIGS. 6 and 6A, each liner 20a, 20b, 20c has a double-walled construction, with air between the two walls serving as an insulator. As mentioned above, a cover 26a, 26b, 26c may be placed over the open end 24a, 24b, 24c of each liner 20a, 20b, 20c to reduce heat loss to the coffee after brewing. Of course, the liners 20a, 20b, 20c can be sized to accommodate various volumes of brewed coffee, such as, for example, 3, 6, or 10 gallons.

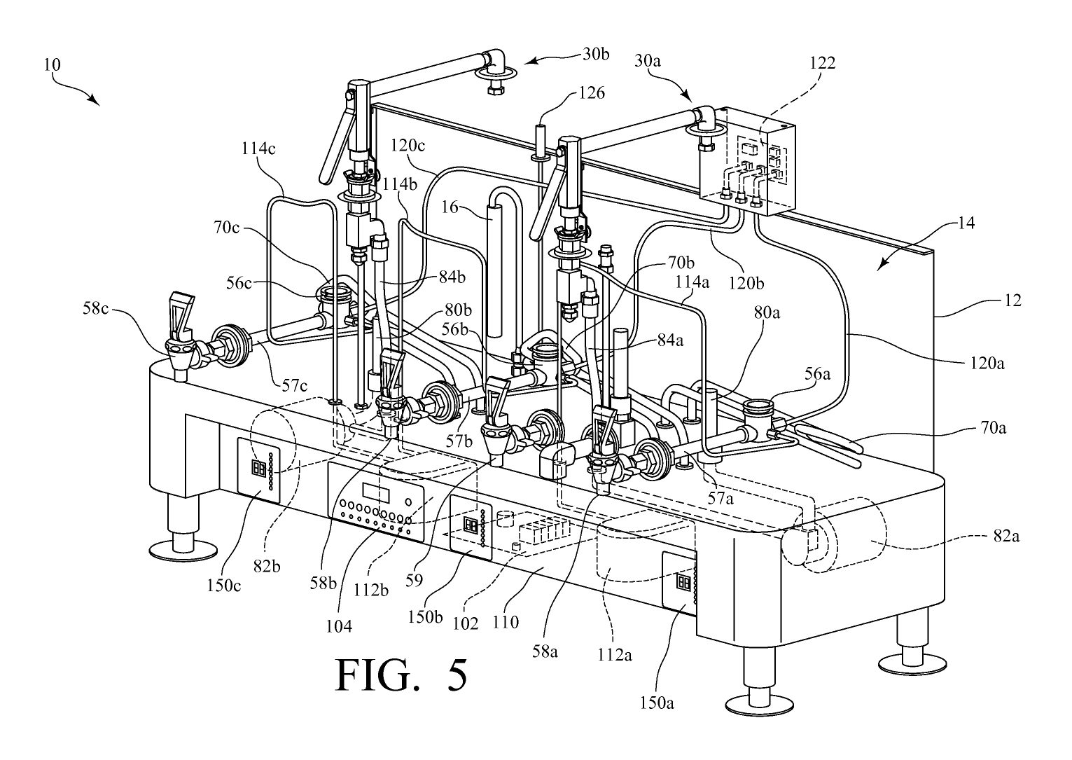

Referring now to FIG. 5, the heating elements 70a, 70b, 70c in the interior cavity 14 of the housing 12 are “staggered,” with a respective heating element 70a, 70b, 70c positioned near each liner 20a, 20b, 20c, in an effort to maintain a consistent water temperature. As discussed above, in prior urn constructions, the heating elements are commonly positioned in the center of the interior cavity (or tank), and as such, the temperature of the water near one liner might be greater than that of another liner. Such differences in temperature can lead to quality issues with respect to the brewed coffee. By staggering the heating elements 70a, 70b, 70c and positioning each heating element 70a, 70b, 70c near a respective liner 20a, 20b, 20c, consistent and optimal brewed coffee temperatures can be maintained at each liner 20a, 20b, 20c.

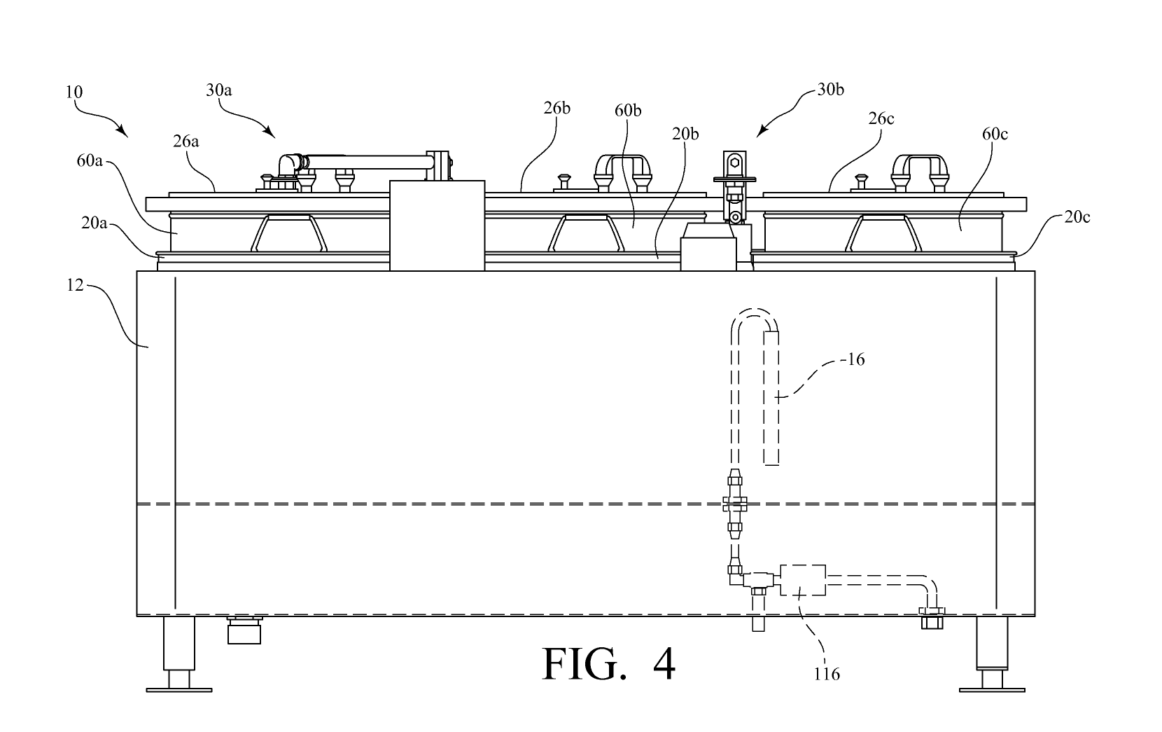

Referring still to FIG. 5, as mentioned above, a volume of water is stored in the interior cavity 14, such that the housing 12 also acts as a hot water tank, at a optimal coffee brewing temperature of approximately 200° F. to 205° F. (slightly higher than the brewed coffee held within each liner 20a, 20b, 20c), with water held in the tank and surrounding each of the three liners 20a, 20b, 20c (which are not shown in FIG. 5 so the other internal components are viewable). In this regard, water is delivered into the interior cavity 14 through the inlet pipe 16 (as also shown in FIG. 4) that is operably connected to an external water source (not shown), with the introduction of water into the interior cavity 14 through the inlet pipe 16 being controlled by the fill valve 116, as is further described below. As mentioned above, hot water from the tank is delivered to the three liners 20a, 20b, 20c and through respective three brew baskets 60a, 60b, 60c received in the liners 20a, 20b, 20c by two spray arm assemblies 30a, 30b. Specifically, water is drawn through a pump inlet 80a, 80b by a respective pump 82a, 82b (or similar means for conveying water), and then delivered through a respective outlet pipe 84a, 84b to one of the two spray arm assemblies 30a, 30b. Although there are three liners 20a, 20b, 20c, there are only two spray arm assemblies 30a, 30b, as each spray arm assembly 30a, 30b is configured for pivotal movement relative to the housing 12 and between two of the liners 20a, 20b, 20c. The first spray arm assembly 30a pivots to allow water to be added to the right and center liners 20a, 20b, while the other spray arm assembly 30b pivots to allow water to be added to left and center liners 20c, 20b.

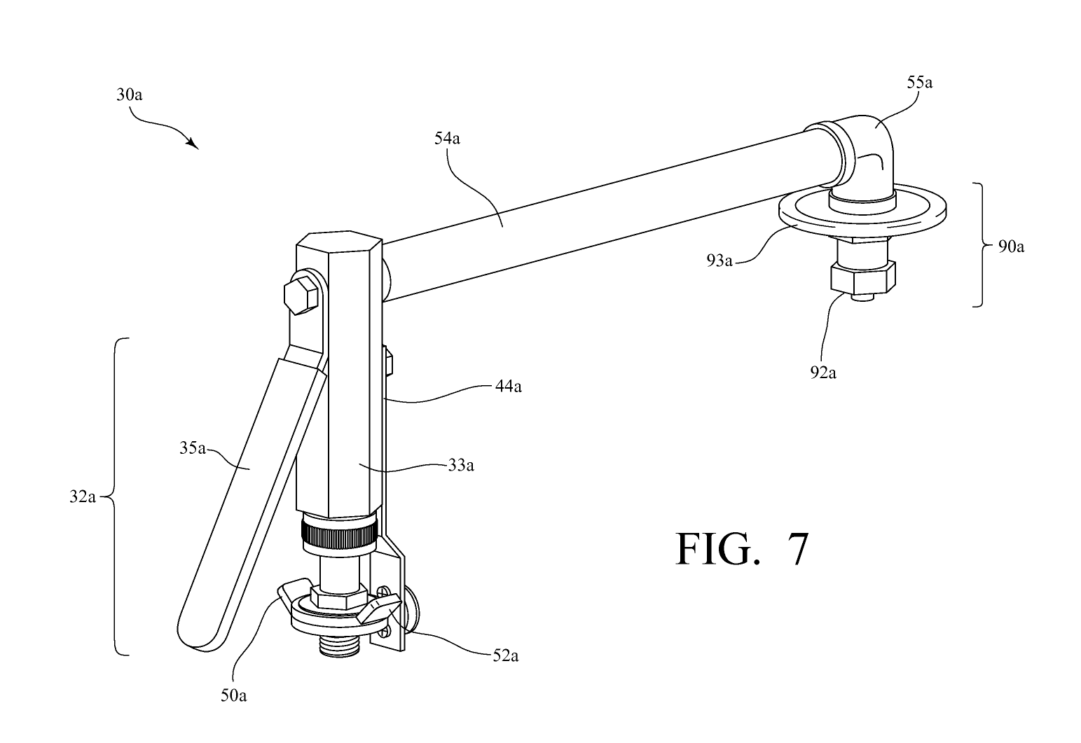

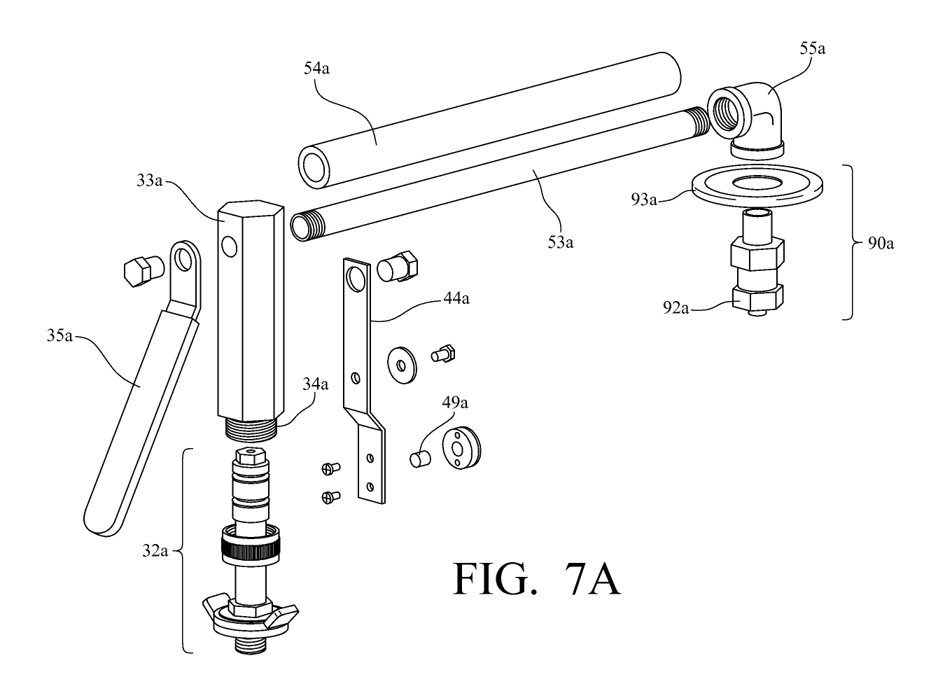

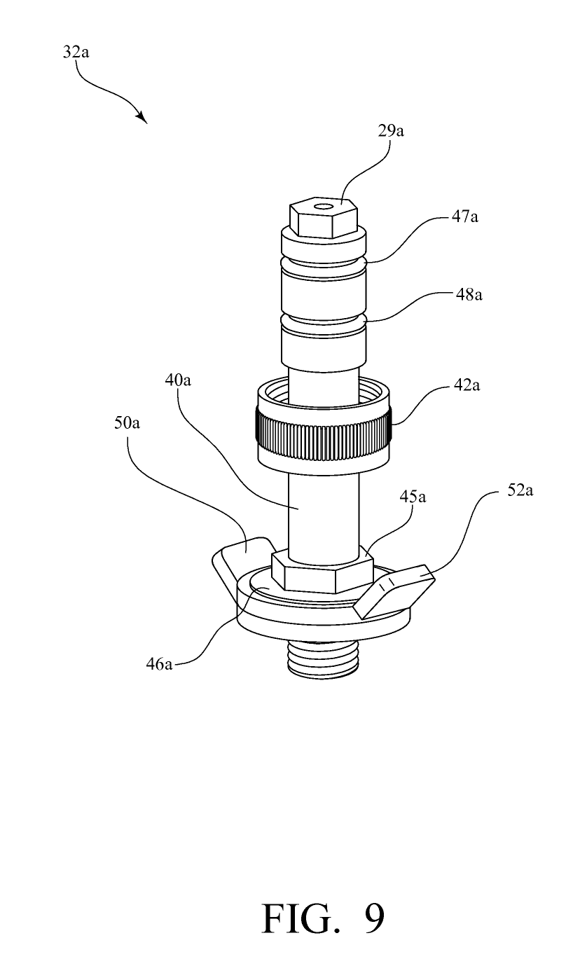

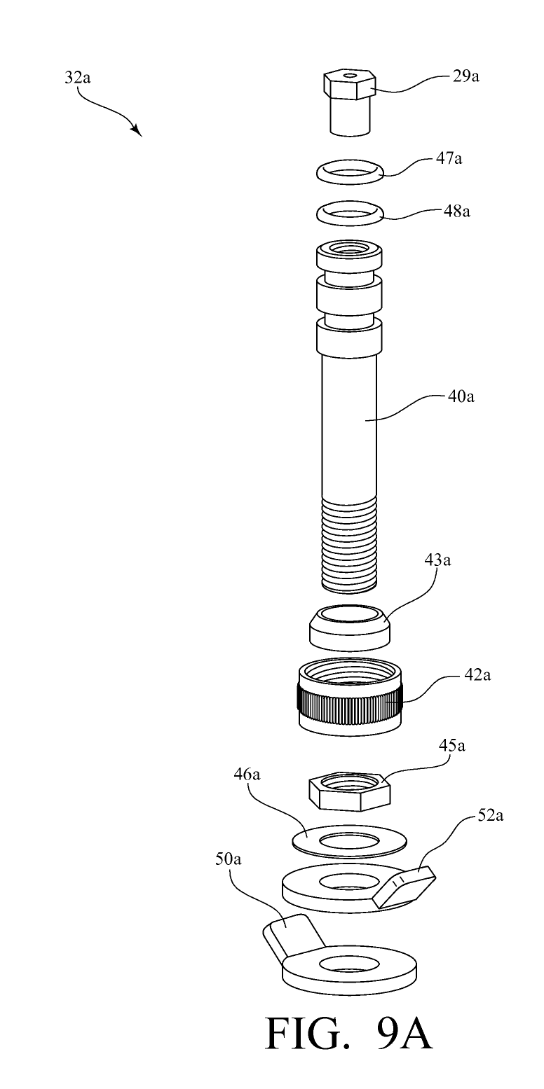

FIGS. 7 and 7A provide more detailed views of the spray arm assembly 30a in this exemplary embodiment, while FIGS. 9 and 9A illustrate the post assembly 32a of the spray arm assembly 30a to assist in explaining the construction that facilitates the pivotal movement of the spray arm assembly 30a relative to the housing 12.

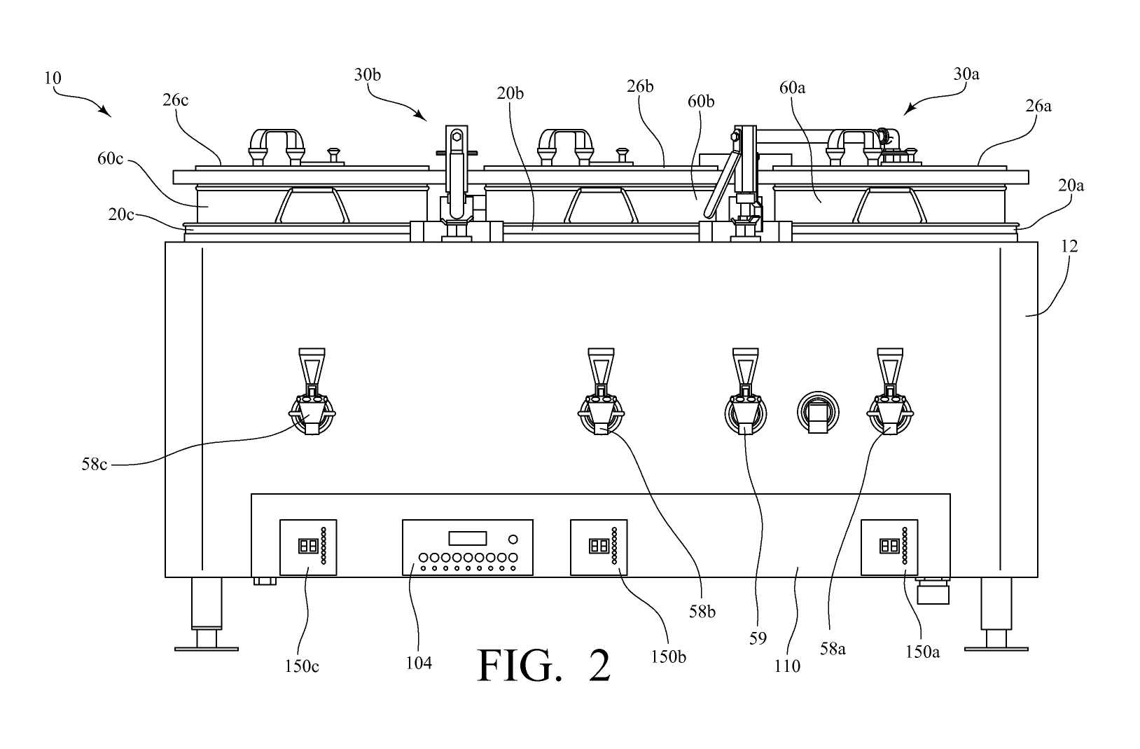

Referring first to FIGS. 9 and 9A, the post assembly 32a includes a central shaft 40a that defines an internal channel for the flow of water, as is further described below. The lower end of this central shaft 40a passes through a ring seal 43a, through a knurled adjustment knob 42a that includes internal threads, and then into the housing 12 of the exemplary coffee brewing system 10 (as shown in FIGS. 1, 1A, and 2) where it is secured by a nut (which is shown in FIG. 5).

Referring still to FIGS. 9 and 9A, a lower nut 45a is screwed onto the threads 41a on the external surface of the central shaft 40a. A washer 46a is then placed over the central shaft 40a below the lower nut 45a, followed by two washer-like elements, each with a tab extending therefrom, that serve as left and right stops 50a, 52a, as is further described below. At the opposite, upper end of the central shaft 40a, two O-rings 47a, 48a are placed over the central shaft 40a, and a nozzle 29a is inserted into the internal channel defined by the central shaft 40a.

Returning now to FIGS. 7 and 7A, a sleeve 33a is positioned over and secured to the distal end of the post assembly 32a. The sleeve 33a also defines an internal channel, receiving water from the internal channel defined through the post assembly 32a, and the above-described O-rings 47a, 48a seal the sleeve 33a relative to the central shaft 40a to prevent any water leakage. The sleeve 33a includes threads 34a at its lower end that engage the internal threads of the adjustment knob 42a. Thus, during assembly, the adjustment knob 42a is moved up the central shaft 40a into engagement with the threads 34a of the sleeve 33a, and then rotated to operably connect the adjustment knob 42a to the sleeve 33a, with the above-described ring seal 43a pressed into the open end of the adjustment knob 42a. As a result, once assembled, the sleeve 33a will rotate with the adjustment knob 42a around and relative to the central shaft 40a. Such rotation is facilitated by a handle 35a secured to the sleeve 33a.

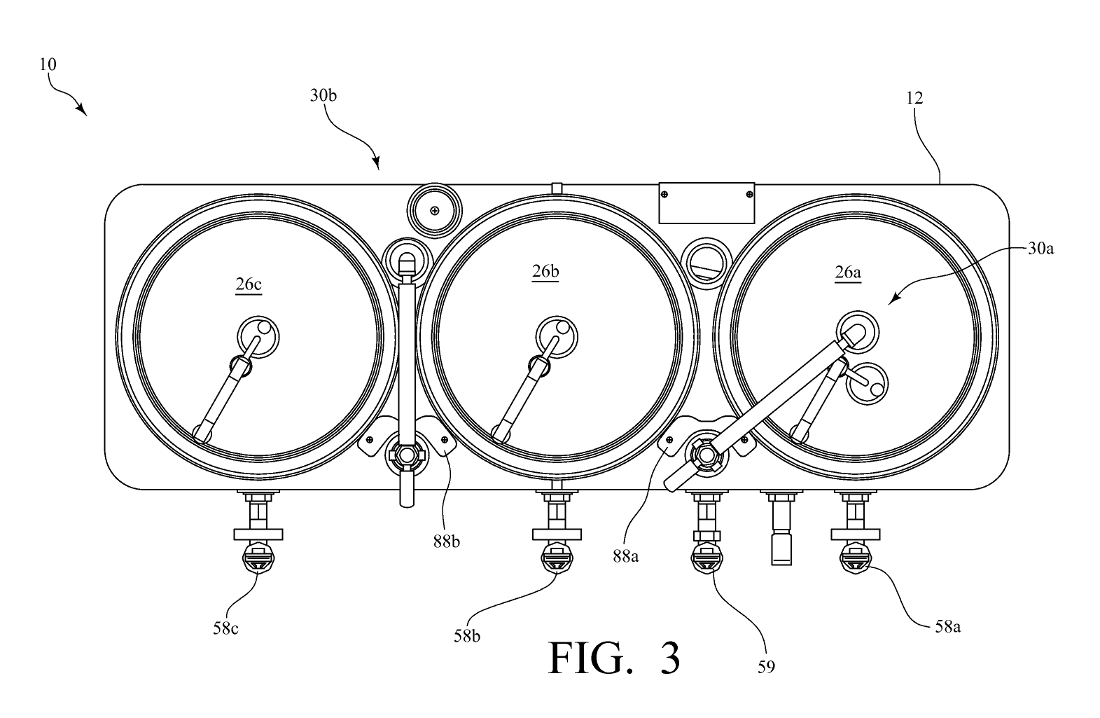

Referring still to FIGS. 7 and 7A, a water delivery tube 53a is connected to the sleeve 33a at its upper end and receives water flowing through the post assembly 32a and the sleeve 33a. This water delivery tube 53a (which is covered by an insulating sleeve 54a) then carries the water through an elbow 55a to a spray head assembly 90a. In the exemplary embodiment shown in FIGS. 7 and 7A, the spray head assembly comprises a nozzle 92a and a vapor shield 93a. When the first spray arm assembly 30a is positioned over a liner 26a (as shown in FIG. 3), the cover 26a often remains in place, and the nozzle 92a is inserted through an access hole in the cover 26a. The vapor shield 93a would thus shield or hinder vapors from escaping from the liner 20a.

Furthermore, with respect to the spray arm assembly 30a and FIGS. 7 and 7A, a downwardly extending bracket 44a is also secured to the sleeve 33a by one or more fasteners. This bracket 44a pivots with the pivoting of the spray arm assembly 30a, and will engage the left and right stops 50a, 52a at the base of the post assembly 32a to prevent over-rotation of the spray arm assembly 30a. Furthermore, a magnet 49a is preferably secured near the distal end of this bracket 44a in a retainer or enclosure. Referring back to FIGS. 1-4, a magnetic proximity sensor assembly 88a, 88b is located near the base of the respective post assembly 32a, 32b of each of the spray arm assemblies 30a, 30b. These magnetic proximity sensor assemblies 88a, 88b can provide information as to the position of each spray arm assembly 30a, 30b by sensing the relative position of the magnet 49a, 49b secured near the distal end of the respective brackets 44a, 44b, as further described below. In this regard, in this exemplary embodiment, each magnetic proximity sensor assembly 88a, 88b includes two independent sensors that are housed within a common enclosure. Of course, other magnetic or non-magnetic proximity sensors could also be incorporated into the exemplary coffee brewing system 10 without departing from the spirit or scope of the present invention.

Again, as a result of the pivoting capabilities, the first spray arm assembly 30a can be positioned over the right and center liners 20a, 20b, or in a park position between the two liners. The second spray arm assembly 30b can be positioned over the center and left liners 20b, 20c, or in a park position between the two liners.

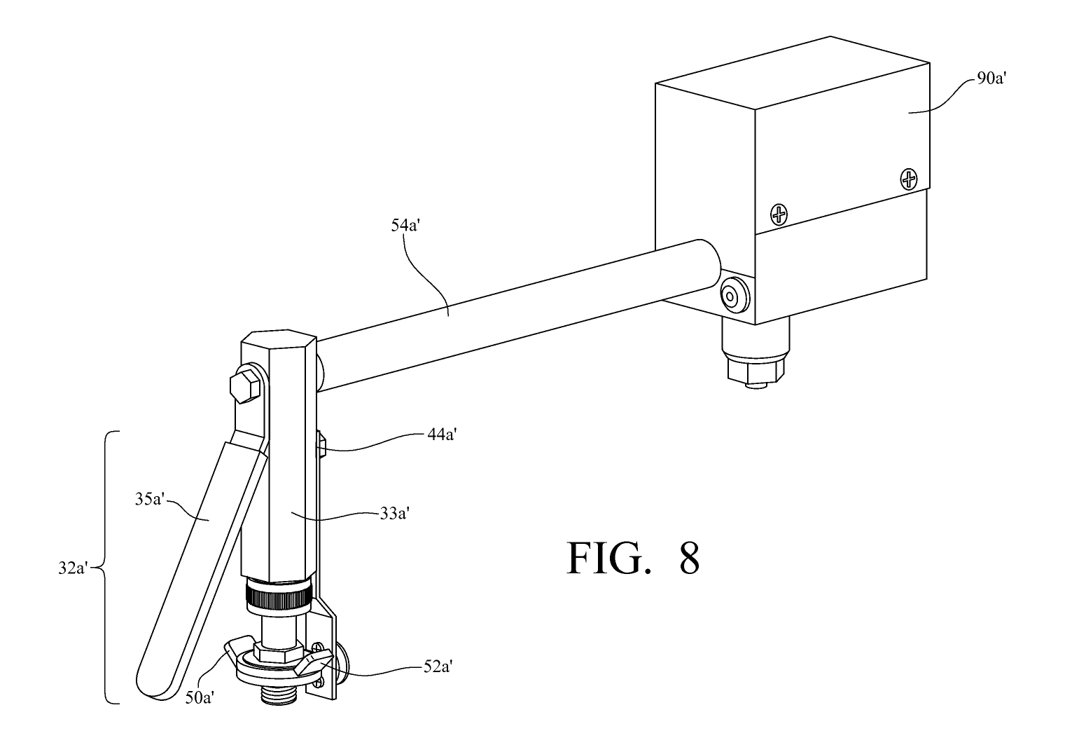

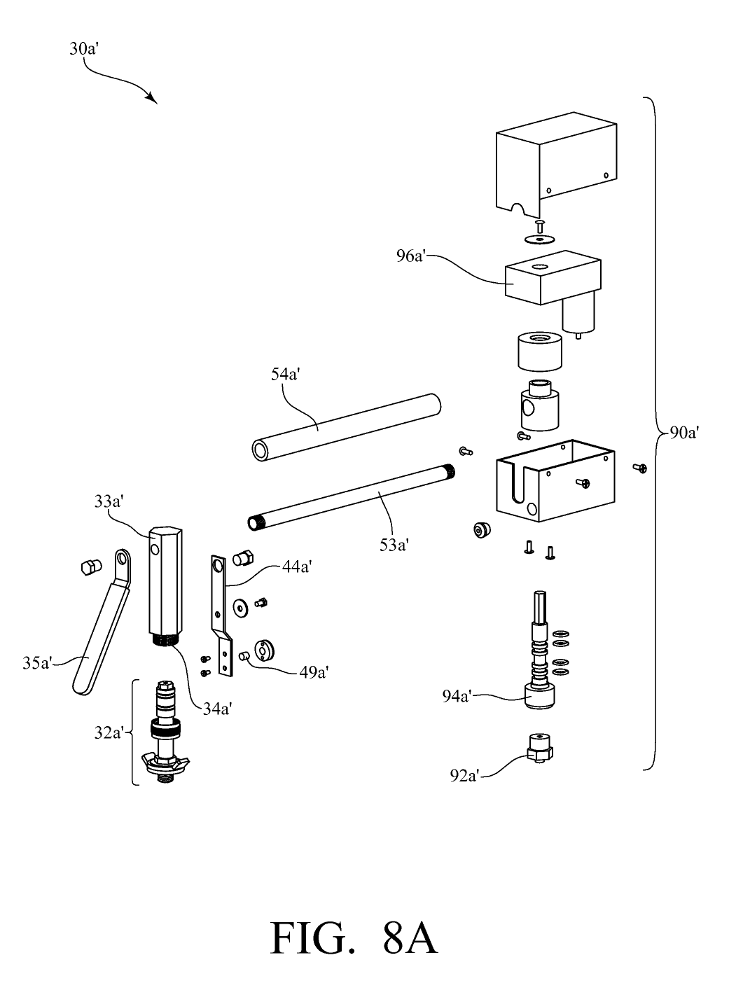

FIGS. 8 and 8A are, respectively, perspective and exploded perspective views, of an alternate spray arm assembly 30a′ for use with an exemplary coffee brewing system made in accordance with the present invention. This alternate spray arm assembly 30a′ is identical to the spray arm assembly 30a described above with reference to FIGS. 7 and 7A, with the exception that, in this alternate embodiment, at the end of the spray arm assembly 30a′, there is a rotating spray head assembly 90a′ that delivers the hot water to the underlying brew basket. By using such a rotating spray head assembly 90a′, the coffee grounds in the underlying brew basket are stirred to some extent, ensuring that the coffee grounds are uniformly saturated, especially if a large amount of coffee grounds are used in a brew batch. As shown in the exploded perspective view of FIG. 8A, in the rotating spray head assembly 90a′, the spray head (or nozzle) 92a′ is located at the distal end of a hollow shaft 94a′, and this hollow shaft 94a′ is rotated by a gear box 96a′ driven by a 24-VDC motor. The hollow shaft 94a′ rotates at approximately 30 revolutions per minute, causing the water to spray substantially over all of the coffee grounds in the underlying brew basket.

Referring again to FIGS. 1-5, brewed coffee is dispensed from each liner 20a, 20b, 20c via a dispensing nozzle 58a, 58b, 58c on the external surface of the housing 12 that is in fluid communication with a respective liner 20a, 20b, 20c via a delivery tube 57a, 57b, 57c. In this exemplary embodiment, each liner 20a, 20b, 20c is connected to a coupling 56a, 56b, 56c, which places each liner 20a, 20b, 20c in fluid communication with a respective delivery tube 57a, 57b, 57c. Also, in this exemplary embodiment, another dispensing nozzle 59 is in fluid communication with the interior cavity 14 of the housing 12 for delivering hot water directly from the interior cavity 14, if needed.

As a further refinement, the exemplary coffee brewing system 10 includes a pair of air agitation pumps 112a, 112b that are located in a control drawer 110 below the housing 12, as shown in FIG. 5. These air agitation pumps 112a, 112b deliver air to the liners 20a, 20b, 20c through air lines 114a, 114b, 114c connected to couplings 56a, 56b, 56c, as also shown in FIG. 5, in order to agitate the brewed coffee at the end of the brewing cycle or at other selected intervals. These air agitation pumps 112a, 112b can be programmed by the user to automatically agitate the brewed coffee at designated times and/or at predetermined intervals.

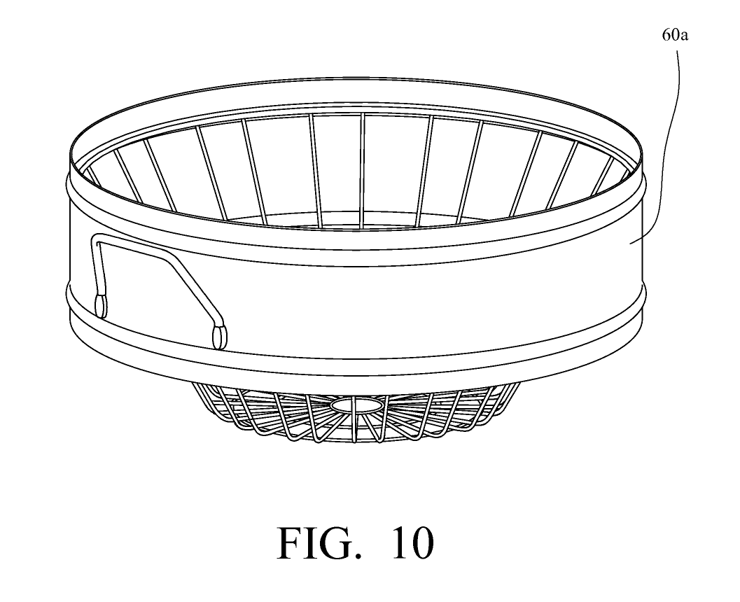

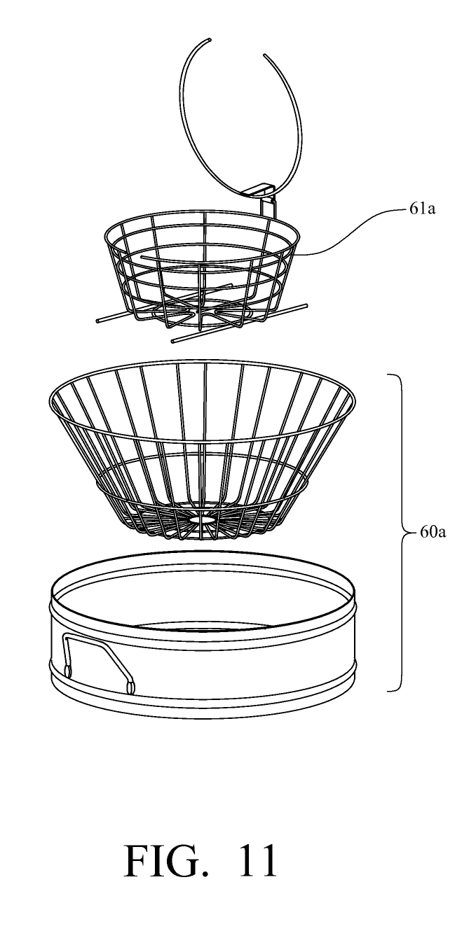

As a further refinement, and referring now to FIGS. 10 and 11, the exemplary coffee brewing system 10 includes brew baskets that can accommodate different amounts of coffee grounds, depending on the amount of brewed coffee to be made. For example, for a 3-gallon liner, approximately 32 ounces of ground coffee are normally placed in a coffee filter (not shown) in the brew basket 60a to brew 3 gallons of coffee. As the hot water is directed over the coffee grounds, the brewed coffee passes through the filter and the openings of the brew basket 60a into the liner. The brew basket 60a is of a sufficient size large enough to accommodate the proper amount of coffee grounds for each batch of coffee.

If it is desirable to brew a smaller batch of coffee, for example, one-half gallon of coffee, a smaller amount of coffee grounds must be used (e.g., approximately 6 ounces). However, placing 6 ounces of coffee grounds in a brew basket designed for 32 ounces will cause the layer of coffee grounds in the brew basket to be too thin and will cause the coffee grounds to be over-extracted. Therefore, in accordance with the teachings of the present invention, it is desirable to use a half batch brew insert 61a that is received in the full batch brew basket 60a for holding a reduced quantity of coffee grounds in the center of the full batch brew basket 60a. The filter (not shown) and coffee grounds are placed in this insert 61a, and so the same coffee brewing system can be used to brew the smaller batch of coffee without any degradation in quality. In this exemplary embodiment, and as shown in FIG. 11, the insert 61a is configured to be placed in the center of the full batch brew basket 60a and accommodates a smaller filter. Furthermore, the insert 61a may include a ring that can be pivoted down into position over the insert 61a to keep it from collapsing when water is sprayed into the insert 61a.

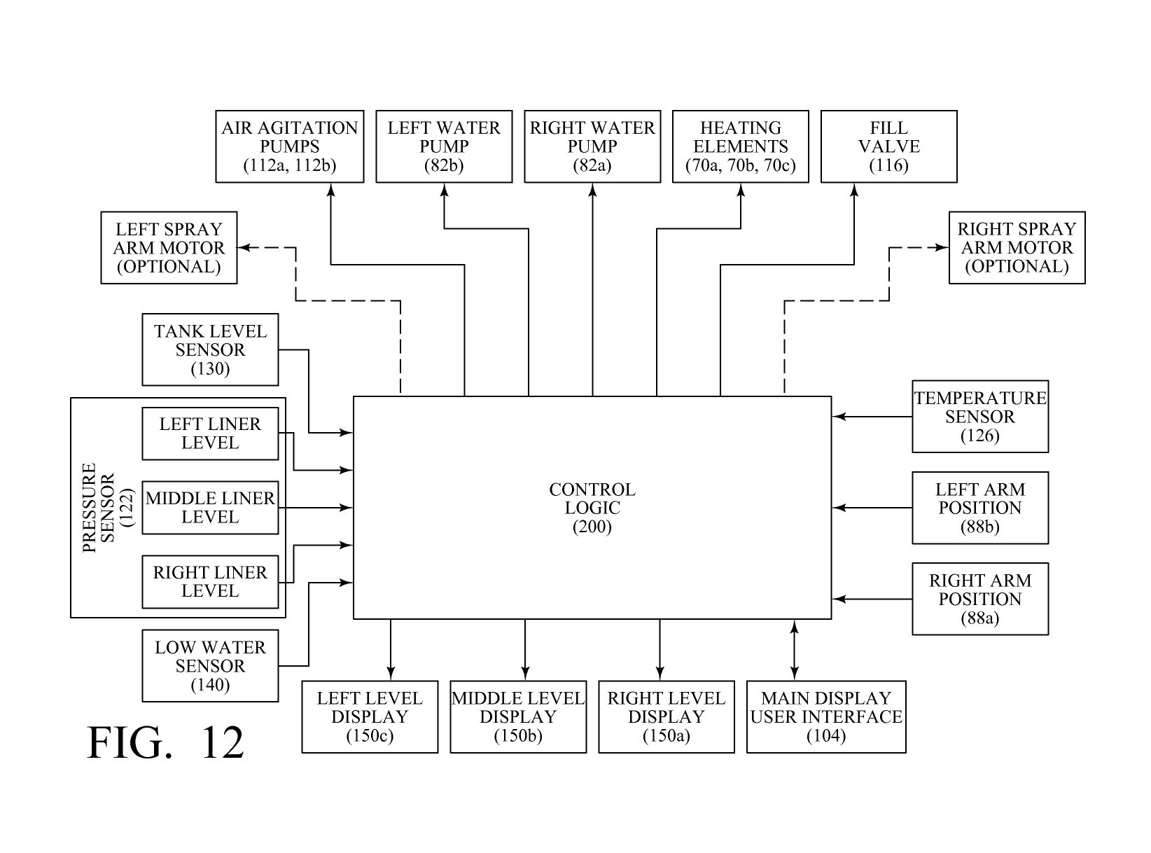

FIG. 12 is a schematic diagram of the control system for the exemplary coffee brewing system of FIGS. 1-5. There is a control logic 200 on an electronic control board 102 (shown in FIG. 5) that is used to control: the pair of air agitation pumps 112a, 112b; the left and right water pump 82a, 82b; the heating elements 70a, 70b, 70c; the motors 98a′, 98b′ associated with the respective rotating spray head assemblies 90a′, 90b′ (for the alternate pivoting spray arm assemblies 30a′, 30b′ shown in FIGS. 8 and 8A); and a fill valve 116 (FIG. 4). In determining how to control these various components, the control logic 200 relies on inputs from various sensors and from the user via the main display user interface 104.

First, the control logic receives signals from the magnetic proximity sensor assemblies 88a, 88b located near the base of the lower post assemblies 32a, 32b of the spray arm assemblies 30a, 30b, signals that are representative of the relative position of each spray arm assembly 30a, 30b. In this regard, and as mentioned above, in this exemplary embodiment, each magnetic proximity sensor assembly 88a, 88b includes two independent sensors that each provide a signal to the control logic 200. Thus, the control logic 200 can verify the position of the spray arm assemblies 30a, 30b before starting a brew cycle. For example, if a spray arm assembly 30a is pivoted away from the spray-over position while it is brewing, the magnetic proximity sensor assembly 88a will sense the movement and the control logic 200 will then terminate the brew cycle. If the spray arm assembly 30a is positioned incorrectly while starting a brew cycle, a notification will be displayed to the operator via the main display user interface 104, notifying the operator that the spray arm assembly 30a is in the wrong position, and the control logic 200 will prevent the brew cycle from starting.

Referring again to FIG. 5, the exemplary coffee brewing system 10 also includes a length of tubing 120a, 120b, 120c that extends from the coupling 56a, 56b, 56c at the bottom of each of the liners 20a, 20b, 20c and is in fluid communication with the internal volume 22a, 22b, 22c defined by each of the liners 20a, 20b, 20c. The opposite end of each length of tubing 120a, 120b, 120c is operably connected to a pressure sensor 122. The pressure sensor 122 communicates a signal to the control logic 200 representative of the measured head pressure in each length of tubing 120a, 120b, 120c. Since the pressure in each length of tubing 120a, 120b, 120c is dependent on the volume of brewed beverage in a respective liner 20a, 20b, 20c, by measuring the pressure, the liquid level in each liner can be determined by the control logic 200.

In this exemplary embodiment, there is also a temperature sensor (thermistor) 126 within the interior cavity 14 of the housing 12 near the inlet pipe 16 to measure the water temperature. The temperature sensor 126 communicates a signal to the control logic 200 representative of the measured water temperature, so that the control logic 200 can determine when to activate or deactivate the heating elements 70a, 70b, 70c.

In this exemplary embodiment, there is also a tank level sensor 130 within the interior cavity 14 of the housing 12, with the tank level sensor 130 communicating a signal to the control logic 200 representative of whether or not the tank is full. If not, the control logic 200 can open the fill valve 116. If the tank is full, the control logic 200 can close the fill valve 116.

In this exemplary embodiment, there is also a low water sensor 140 within the interior cavity 14 of the housing 12, with the low water sensor 140 communicating a signal to the control logic 200 representative of whether the water level is so low. If so, the control logic 200 can deactivate the heating elements 70a, 70b, 70c.

Finally, as shown in FIG. 12, the control logic 200 communicates with three level displays 150a, 150b, 150c, each of which provides a visual indication of the liquid level in a particular liner 20a, 20b, 20c. Such three level displays replace common sight glasses, which, as discussed above, are often fragile and also difficult to read when residue accumulates on the sight glass. Residue from the sight glass can also contaminate future batches of coffee, and when using a sight glass, the temperature of the coffee is lowered because a portion of the coffee that is poured out into each cup comes from the portion of coffee in the sight glass. As mentioned above, the pressure sensor 122 measures the head pressure created by the brewed coffee contained in each liner 20a, 20b, 20c. In this exemplary embodiment, the level is then displayed via an 8-LED bar graph, with each LED representing approximately ⅛ of the volume of coffee in the liner 20a, 20b, 20c. The pressure sensor 122 and level displays 150a, 150b, 150c thus allows an operator to readily ascertain the volume of brewed coffee in each liner 20a, 20b, 20c in a safe manner while also maintaining the proper temperature.

In practice, to begin a new brew cycle, an amount of coffee grounds is placed in the brew basket 60a. Then, one of the pivoting spray arm assemblies 30a, 30b (depending on which liner is to be used) is pivoted over the selected liner 20a, 20b, 20c. When the selected pivoting spray arm assembly 30a, 30b is in the proper position, the control logic 200 initiates the brewing process. Hot water from the hot water tank is distributed over the coffee grounds via the selected spray arm assembly 30a, 30b. The control logic 200 controls this distribution of hot water over the coffee grounds in the manner described above to ensure a consistent and high-quality brewed coffee. In this regard, the control logic 200 may also allow a user to control contact time between the hot water and the coffee grounds through “pulse brewing.” During “pulse brewing,” the water flow can be adjusted such that not all the water is added at once, but rather in “pulses.” Thus, by adding water in “pulses,” the amount of time the water is in contact with the coffee grounds can be increased, and a stronger coffee can be brewed. For further description of “pulse brewing,” reference is made to commonly owned U.S. Pat. No. 7,047,870 entitled “Apparatus and Method for Brewing a Beverage with a Desired Strength,” which is incorporated herein by reference.

Furthermore, automatic air agitation of the brewed coffee within the liner 20a, 20b, 20c ensures the consistency of each cup of coffee dispensed. In this regard, and as mentioned above, the brewed coffee can be dispensed from the liner 20a, 20b, 20c via a dispensing nozzle 58a, 58b, 58c that is in fluid communication with a respective liner 20a, 20b, 20c. Also, in this exemplary embodiment, another dispensing nozzle 59 is in fluid communication with the interior cavity 14 of the housing 12 for distributing hot water as needed.

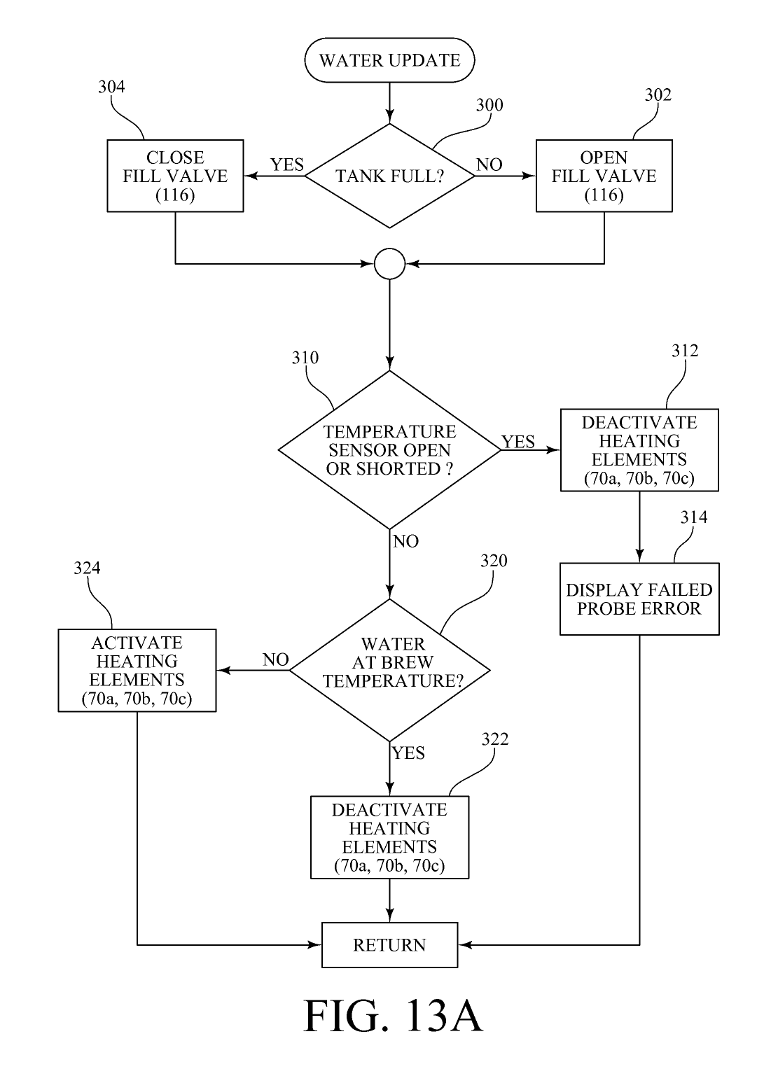

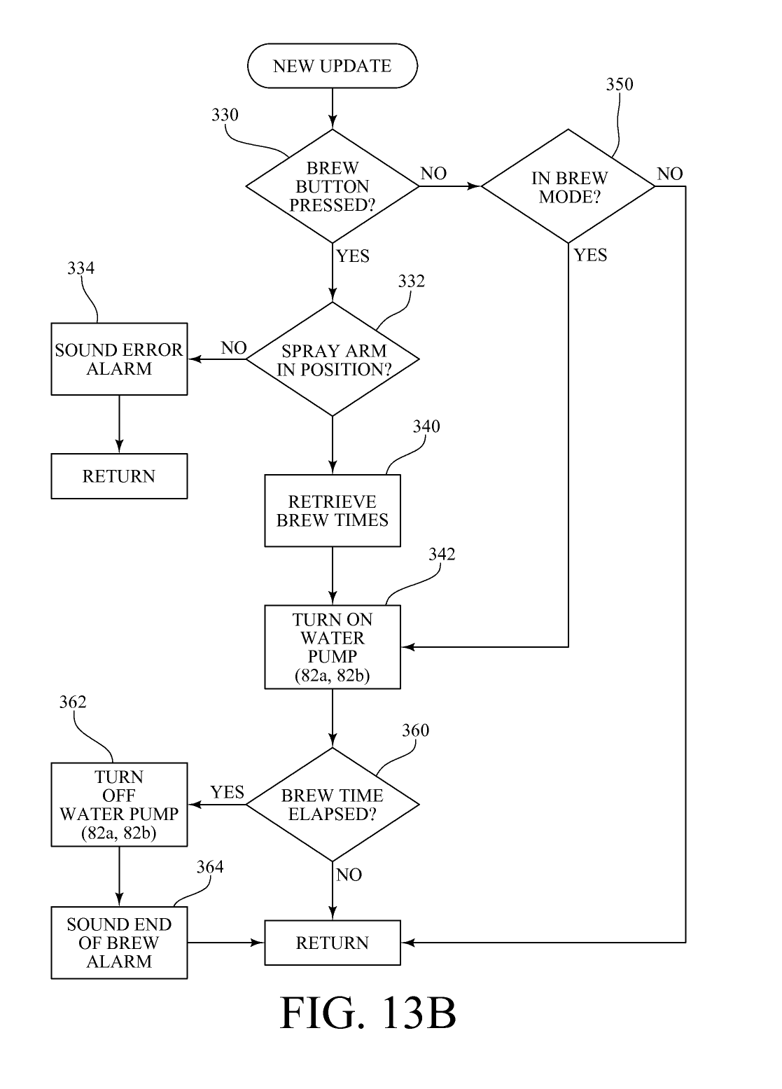

For further illustration of the function of the control logic 200, FIGS. 13A AND 13B are logic diagrams that illustrate exemplary subroutines carried out by the control logic 200 in this exemplary coffee brewing system 10.

FIG. 13A illustrates the evaluation of the water level within the interior cavity 14 of the housing 12. As described above, the tank level sensor 130 communicates a signal to the control logic 200 representative of whether or not the tank is full. Thus, in this water updating subroutine, a determination is made by the control logic 200 at decision 300 as to whether the tank is full. If not, the control logic 200 opens the fill valve 116, as indicated by block 302. If the tank is full, the control logic 200 closes the fill valve 116, as indicated by block 304. Then, the control logic 200 evaluates whether the temperature sensor 126 is open or shorted at decision 310. If so, the control logic 200 turns off the heating elements 70a, 70b, 70c, as indicated by block 312, and the control logic 200 causes a “failed probe error” message to be displayed via the main display user interface 104, as indicated by block 314. If the temperature sensor 126 is functioning properly, the control logic 200 then evaluates whether the water is at brew temperature at decision 320. Such an evaluation is based on the signal communicated from the temperature sensor 126 to the control logic 200 representative of the measured water temperature. If so, the control logic 200 deactivates the heating elements 70a, 70b, 70c, as indicated by block 322. If not, the control logic 200 activates the heating elements 70a, 70b, 70c, as indicated by block 324.

FIG. 13B illustrates the control of a brew cycle. First, a determination is made by the control logic 200 as to whether the brew button (an input accessible via the main display user interface 104) has been pressed at decision 330. If so, a determination is made by the control logic 200 as to whether the selected spray arm assembly 30a, 30b is in position at decision 332. If not, the control logic 200 sounds an alarm, as indicated by block 334, and the control logic 200 may also cause an appropriate notification to be displayed via the main display user interface 104. If the selected spray arm assembly 30a, 30b is in position, the control logic retrieves a predetermined brew time from a memory storage associated with the control logic 200, as indicated by block 340. The control logic 200 then turns on the appropriate water pump 82a, 82b, as indicated by block 342. Returning to decision 330, if the brew button has not been pressed, a subsequent determination is made by the control logic 200 as to whether a brew cycle is already active at decision 350, and if so, the control logic 200 similarly turns on the appropriate water pump 82a, 82b, as indicated by block 342. Once the appropriate water pump 82a, 82b has been turned on, it remains on until the control logic 200 make a determination at decision 360 as to whether the predetermined brew time has elapsed. If so, the control logic 200 then turns off the water pump 82a, 82b, as indicated by block 362. The control logic 200 then sounds an “end of brew” alarm, as indicated by block 364, and the control logic 200 may also cause an appropriate notification to be displayed via the main display user interface 104.

As a further refinement, the exemplary coffee brewing system 10 may also include a bypass valve (not shown) integral with each spray arm assembly 30a, 30b to allow up to 40% of the water volume to be bypassed directly into a liner 20a, 20b, 20c instead of through a selected pivoting spray arm assembly 30a, 30b. Such a bypass valve would allow a portion of the water to enter directly into one of the liners 20a, 20b, 20c to dilute the brewed coffee without contacting the coffee grounds and the brew baskets.

As yet a further refinement, the exemplary coffee brewing system 10 may include one coffee hold timer for each liner 20a, 20b, 20c. The coffee hold timer would indicate how long a batch of brewed coffee has been sitting in the liner. The coffee hold timer would be integrated into the housing 12, so it will not get lost or dropped, as could happen to non-integrated timers. The timer would also communicate directly with the control logic 200. Once a new batch of coffee is being brewed, the coffee hold timer for that particular liner 20a, 20b, 20c would automatically be started and count down a programmable amount of time. Once the coffee hold timer counted down to zero, the control logic 200 would activate an alarm to indicate a new batch of coffee needs to be brewed.

One of ordinary skill in the art will also recognize that additional embodiments are possible without departing from the teachings of the present invention or the scope of the claim which follow. This detailed description, and particularly the specific details of the exemplary embodiments disclosed therein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A coffee brewing system, comprising:
a housing defining an interior cavity for storing a volume of water;
a fill valve for controlling flow of water into the interior cavity through an inlet pipe;
a plurality of liners housed within the interior cavity and surrounded by the water in the interior cavity;
one or more heating elements positioned within the interior cavity to heat and maintain the temperature of the water;
a plurality of brew baskets, each of which is received in one of the plurality of liners and configured for holding a quantity of coffee grounds;
a plurality of pivoting spray arm assemblies, each said pivoting spray arm assembly configured for pivotal movement relative to the housing;
one or more pumps, each said pump for conveying water from the interior cavity of the housing to a respective pivoting spray arm assembly, which then delivers the water to a selected brew basket for making a brewed coffee; and
a control system for controlling operation of each said pump, each said heating element, and said fill valve.

2. The coffee brewing system as recited in claim 1, and further comprising one or more proximity sensors, each said proximity sensor being located near one of the pivoting spray arm assemblies, with the control system receiving a signal from each said proximity sensor representative of a relative position of each said pivoting spray arm assembly, the control system preventing said one or more pumps from being turned on unless a selected pivoting spray arm assembly is in a predetermined position.

3. The coffee brewing system as recited in claim 1, in which each said pivoting spray arm assembly includes a post assembly for facilitating the pivotal movement of each said pivoting spray arm assembly relative to the housing.

4. The coffee brewing system as recited in claim 3, in which each said pivoting spray arm assembly further includes a downwardly extending bracket that pivots with said pivoting spray arm assembly and engages left and right stops at a base of said post assembly to prevent over-rotation of said pivoting spray arm assembly.

5. The coffee brewing system as recited in claim 4, and further comprising:
a magnet secured near a distal end of the downwardly extending bracket of each said pivoting spray arm assembly; and
one or more magnetic proximity sensor assemblies, each said magnetic proximity sensor assembly being located near the base of said post assembly of one of the pivoting spray arm assemblies, each said magnetic proximity sensor assembly sensing a relative position of the magnet associated with that pivoting spray arm assembly, and each said magnetic proximity sensor assembly then communicating a signal to the control system representative of the relative position of the pivoting spray arm assembly.

6. The coffee brewing system as recited in claim 5, in which each said magnetic proximity sensor assembly includes two independent sensors that are housed within a common enclosure.

7. The coffee brewing system as recited in claim 1, in which one heating element is positioned near each of the plurality of liners.

8. The coffee brewing system as recited in claim 1, and further comprising:
multiple lengths of tubing, each said length of tubing in fluid communication with the interior cavity defined by one of the plurality of liners; and
a pressure sensor connected to a distal end of each said length of tubing, said pressure sensor communicating a signal to the control system representative of the measured head pressure in each said length of tubing.

9. The coffee brewing system as recited in claim 8, and further comprising multiple level displays, each said level display associated with one of the plurality of liners, each said level display receiving a signal from the control system representative of the liquid level in the associated liner based on the measured head pressure, each said level display then providing a visual indication of the liquid level in the associated liner.

10. The coffee brewing system as recited in claim 1, and further comprising a temperature sensor within the interior cavity defined by the housing, said temperature sensor communicating a signal to the control system representative of the measured water temperature, with the control system activating or deactivating the heating elements in response to the measured water temperature.

11. The coffee brewing system as recited in claim 1, and further comprising one or more air agitation pumps configured to deliver air to each of the plurality of liners to agitate the brewed coffee at designated times and/or at predetermined intervals.

12. The coffee brewing system as recited in claim 1, in which each said pivoting spray arm assembly includes a rotating spray head assembly for delivering the water to the selected brew basket for making the brewed coffee.

13. The coffee brewing system as recited in claim 1, in which each of the plurality of liners has a double-walled construction.

14. The coffee brewing system as recited in claim 1, in which each brew basket includes an insert that can be selectively received in each brew basket for holding a reduced quantity of coffee grounds in the center of each brew basket.

15. A coffee brewing system, comprising:
a housing defining an interior cavity for storing a volume of water;
a fill valve for controlling flow of water into the interior cavity through an inlet pipe;
a plurality of liners housed within the interior cavity and surrounded by the water in the interior cavity, each said liner connected to a coupling which places each said liner in fluid communication with a respective delivery tube, which delivers a brewed coffee from each said liner to a dispensing nozzle on an external surface of the housing;
a plurality of heating elements, each said heating element positioned within the interior cavity near one of the plurality of liners;
a plurality of brew baskets, each of which is received in one of the plurality of liners and configured for holding a quantity of coffee grounds;
a plurality of pivoting spray arm assemblies, each said pivoting spray arm assembly configured for pivotal movement relative to the housing;
a plurality of proximity sensors, each said proximity sensor being located near one of the pivoting spray arm assemblies;
one or more pumps, each said pump for conveying water from the interior cavity of the housing to a respective pivoting spray arm assembly, which then delivers the water to a selected brew basket for making the brewed coffee; and
a control system for controlling operation of each said pump, each said heating element, and said fill valve, the control system further receiving a signal from each said proximity sensor representative of a relative position of each said pivoting spray arm assembly, the control system preventing said one or more pumps from being turned on unless a selected pivoting spray arm assembly is in a predetermined position.

16. The coffee brewing system as recited in claim 15, in which each said proximity sensor is a magnetic proximity sensor assembly configured to sense the relative position of a magnet secured to the pivoting spray arm assembly, with each said magnetic proximity sensor assembly then communicating the signal to the control system representative of the relative position of each said pivoting spray arm assembly.

17. The coffee brewing system as recited in claim 15, and further comprising:
multiple lengths of tubing, each said length of tubing in fluid communication with one of the couplings connected to one of the plurality of liners; and
a pressure sensor connected to a distal end of each said length of tubing, said pressure sensor communicating a signal to the control system representative of the measured head pressure in each said length of tubing.

18. The coffee brewing system as recited in claim 17, and further comprising multiple level displays, each said level display associated with one of the plurality of liners, each said level display receiving a signal from the control system representative of the liquid level in the associated liner based on the measured head pressure, each said level display then providing a visual indication of the liquid level in the associated liner.

19. The coffee brewing system as recited in claim 15, and further comprising one or more air agitation pumps configured to deliver air to each of the couplings connected to the plurality of liners to agitate the brewed coffee at designated times and/or at predetermined intervals.

20. The coffee brewing system as recited in claim 15, and further comprising a temperature sensor within the interior cavity defined by the housing, said temperature sensor communicating a signal to the control system representative of the measured water temperature, with the control system activating or deactivating the heating elements in response to the measured water temperature.

21. A coffee brewing system, comprising:
a housing defining an interior cavity for storing a volume of water;
a fill valve for controlling flow of water into the interior cavity through an inlet pipe;
three liners housed within the interior cavity and surrounded by the water in the interior cavity, each said liner connected to a coupling which places each said liner in fluid communication with a respective delivery tube, which delivers a brewed coffee from each said liner to a dispensing nozzle on an external surface of the housing;
three heating elements, each said heating element positioned within the interior cavity near one of the liners;
three brew baskets, each of which is received in one of the liners and configured for holding a quantity of coffee grounds;
a first pivoting spray arm assembly configured for pivotal movement relative to the housing and between two of the liners;
a second pivoting spray arm assembly configured for pivotal movement relative to the housing and between another two of the liners;
a first proximity sensor located near the first pivoting spray arm assembly;
a second proximity sensor located near the second pivoting spray arm assembly;
a first pump associated with the first pivoting spray arm assembly for conveying water from the interior cavity of the housing to the first pivoting spray arm assembly, which then delivers the water to a selected brew basket for making the brewed coffee;
a second pump associated with the second pivoting spray arm assembly for conveying water from the interior cavity of the housing to the second pivoting spray arm assembly, which then delivers the water to a selected brew basket for making the brewed coffee; and
a control system for controlling operation of the heating elements and the first and second pumps, with (a) the control system further receiving a signal from the first proximity sensor representative of a relative position of the first pivoting spray arm assembly, the control system preventing the first pump from being turned on unless the first pivoting spray arm assembly is in a predetermined position, and (b) the control system further receiving a signal from the second proximity sensor representative of a relative position of the second pivoting spray arm assembly, the control system preventing the second pump from being turned on unless the second pivoting spray arm assembly is in a predetermined position.
